(19) United States
(12) Patent Application Publication
(10) Pub. No.: US 2017/0061647 A1
(43) Pub. Date: Mar. 2, 2017

(54) Biometric Based Authentication for Head-Mountable Displays

(71) Applicants: Thad Eugene STARNER, Mountain View, CA (US); Michael Patrick JOHNSON, Sunnyvale, CA (US); Antonio Bernardo MONTEIRO COSTA, San Francisco, CA (US); Bo WU, Alhambra, CA (US)

(72) Inventors: Thad Eugene STARNER, Mountain View, CA (US); Michael Patrick JOHNSON, Sunnyvale, CA (US); Antonio Bernardo MONTEIRO COSTA, San Francisco, CA (US); Bo WU, Alhambra, CA (US)

(21) Appl. No.: 13/667,147

(22) Filed: Nov. 2, 2012

(51) Int. Cl. G09G 5/00

(52) U.S. Cl. CPC G06T 7/60

(57) ABSTRACT

Methods and systems are provided for authenticating access to a wearable computing device using an authentication object, such as a hand. The wearable computing device comprises a head mountable display (HMD) and an image capture device and has access to a data profile for the authentication object. The wearable computing device provides (e.g., using the HMD) an indication for positioning the authentication object within a field of view of the image capture device. After providing the indication for positioning the authentication object, the wearable computing device receives image data from the image capture device. If the wearable computing device identifies the authentication object in the image data, for example, by matching at least a portion of the image data with data in the data profile, authentication is successful and one or more functions of the wearable computing device can be enabled.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and less obtrusive.

The trend toward miniaturization of computing hardware, peripherals, sensors, detectors, and image and audio processors, among other technologies, has helped open up a field sometimes referred to as “wearable computing.” In the area of image and visual processing and production, it has become possible to consider wearable displays that place a very small image display element close enough to one or both of the wearer's eyes such that the displayed image fills or nearly fills the field of view, and appears as a normal sized image, such as might be displayed on a traditional image display device. The relevant technology may be referred to as “near-eye displays.”

Near-eye displays are fundamental components of wearable displays, also sometimes called “head-mountable displays.” A head-mountable display places a graphic display close to one or both of the wearer's eyes. To generate the images on the display, a computer processing system can be used.

Emerging and anticipated uses of wearable displays include applications in which users interact in real time with an augmented or virtual reality. These applications can be mission-critical or safety-critical in some fields, such as public safety or aviation.

### SUMMARY

In a first aspect, a method is disclosed. The method includes providing, by a wearable computing device, an indication for positioning an authentication object within a field of view of an image capture device. The wearable computing device comprises a head mountable display (HMD) and the image capture device. The method also includes receiving, by the wearable computing device, image data from the image capture device. The method additionally includes identifying the authentication object in the image data. The method further includes, in response to identifying the authentication object in the image data, enabling at least one function of the wearable computing device.

In a second aspect, a wearable computing device is disclosed. The wearable computing device comprises an image capture device, a head mountable display (HMD), at least one processor, and data storage storing instructions that when executed by the at least one processor cause the wearable computing device to perform operations. The operations include causing the HMD to display an indication for positioning an authentication object within a field of view of the image capture device. The operations also include receiving image data from the image capture device. The operations additionally include identifying the authentication object in the image data. The operations further include in response to identifying the authentication object in the image data, enabling at least one function of the wearable computing device.

In a third aspect, a non-transitory computer readable medium having stored thereon instructions that when executed by a wearable computing device cause the wearable computing device to perform operations is disclosed. The operations include causing a head mountable display (HMD) to display an indication for positioning an authentication object within a field of view of an image capture device. The operations also include receiving image data from the image capture device. The operations additionally include identifying the authentication object in the image data. The operations further include, in response to identifying the authentication object in the image data, enabling at least one function of the wearable computing device.

These as well as other aspects, advantages, and alternatives, will become apparent to those of ordinary skill in the art by reading the following detailed description, with reference where appropriate to the accompanying figures.

### BRIEF DESCRIPTION OF THE DRAWINGS

FIGS. 1A and 1B illustrate a wearable computing device that may be used in conjunction with the systems and methods described herein, in accordance with example embodiments.

FIG. 1C illustrates another wearable computing device that may be used in conjunction with the systems and methods described herein, in accordance with an example embodiment.

FIG. 1D illustrates another wearable computing device that may be used in conjunction with the systems and methods described herein, in accordance with an example embodiment.

FIG. 1E illustrates another wearable computing device that may be used in conjunction with the systems and methods described herein, in accordance with an example embodiment.

FIG. 1F illustrates another wearable computing device that may be used in conjunction with the systems and methods described herein, in accordance with an example embodiment.

FIG. 2 illustrates a functional block diagram of an example proximity-sensing system used in a wearable computing system such as those depicted in FIGS. 1A-1F, in accordance with an example embodiment.

FIGS. 3 is a flow chart illustrating example methods for authenticating a HMD using hand-pattern recognition, according to example embodiments.

FIGS. 4A-4D illustrate image data representing a hand that is authenticated using the example method of FIG. 3.

FIG. 5 is a functional block diagram of a computing device that may be used in conjunction with the systems and methods described herein, in accordance with an example embodiment.

FIG. 6 is a schematic illustrating a conceptual partial view of an example computer program product that includes a computer program for executing a computer process on a computing device, in accordance with an example embodiment.

### DETAILED DESCRIPTION

The following detailed description describes various features and functions of the disclosed systems and methods with reference to the accompanying figures. In the figures, similar symbols typically identify similar components, unless context dictates otherwise. The illustrative system and method embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

### I. OVERVIEW

This disclosure relates to methods and systems for authenticating access to a wearable computing device using an authentication object, such as a hand. Authentication can be important to prevent illegitimate access to a wearable computing device, as with other types of computing devices. However, authentication can be more difficult on a wearable computing device due to the lack of input devices, such as a keypad or keyboard, that are typically used to enter passwords or personal identification numbers (PINs) on other types of devices. A trackpad or similar input device can be used to enter a password or PIN on a wearable computing device. However, if the password or PIN is complex, input of the password or PIN could involve many mode or screen switching operations, which can be a difficult and time-consuming process requiring significant visual and manual attention.

As an alternative to trackpad-based authentication, disclosed herein are embodiments in which authentication is based on a wearable computing device identifying an authentication object in image data. The wearable computing device could include a head mountable display (HMD) and an image capture device. The authentication object could be, for example, a hand or other body part, so as to provide for biometric authentication. Alternatively, the authentication object could be any object with a unique visual structure, such as a Quick Response (QR) code.

To provide for a simple and efficient authentication process, the wearable computing device could provide an indication for how the authentication object should be positioned within a field of view of the image capture device. For example, the wearable computing device could cause the HMD to display an outline within which the authentication object is to be positioned. The wearable computing device may receive image data from the image capture device and compare the image data to data in a data profile for the authentication object to determine whether an object in the image data (e.g., an object placed within the outline) is in fact the authentication object. If the wearable computing device identifies the authentication object in the image data, for example, by matching at least a portion of the image data with data in the data profile, authentication is successful and one or more functions of the wearable computing device can be enabled.

To further guide a user through the authentication process, the wearable computing device may cause the HMD to display a video feed based on video data captured by the image capture device. The video feed may also include the outline or other indication for positioning the authentication object. In this way, the user can see how to adjust the authentication object so that it is positioned as indicated. When the wearable computing device determines that an object consistent with the authentication object has been positioned as indicated (e.g., positioned within the outline), the wearable computing device can provide a confirmation to the user, such as by changing the color, thickness, or shape of the displayed outline. The wearable computing device may further determine whether the properly-positioned object can be imaged well enough for identification (e.g., that the lighting conditions are adequate). If so, the wearable computing device may provide a further confirmation to the user, such as by changing the color, thickness, or shape of the displayed outline. If not, the wearable computing device can provide a prompt to the user, for example, to indicate how the image quality can be improved.

### II. EXAMPLE COMPUTING DEVICES AND SYSTEMS

a. Head Mountable Devices

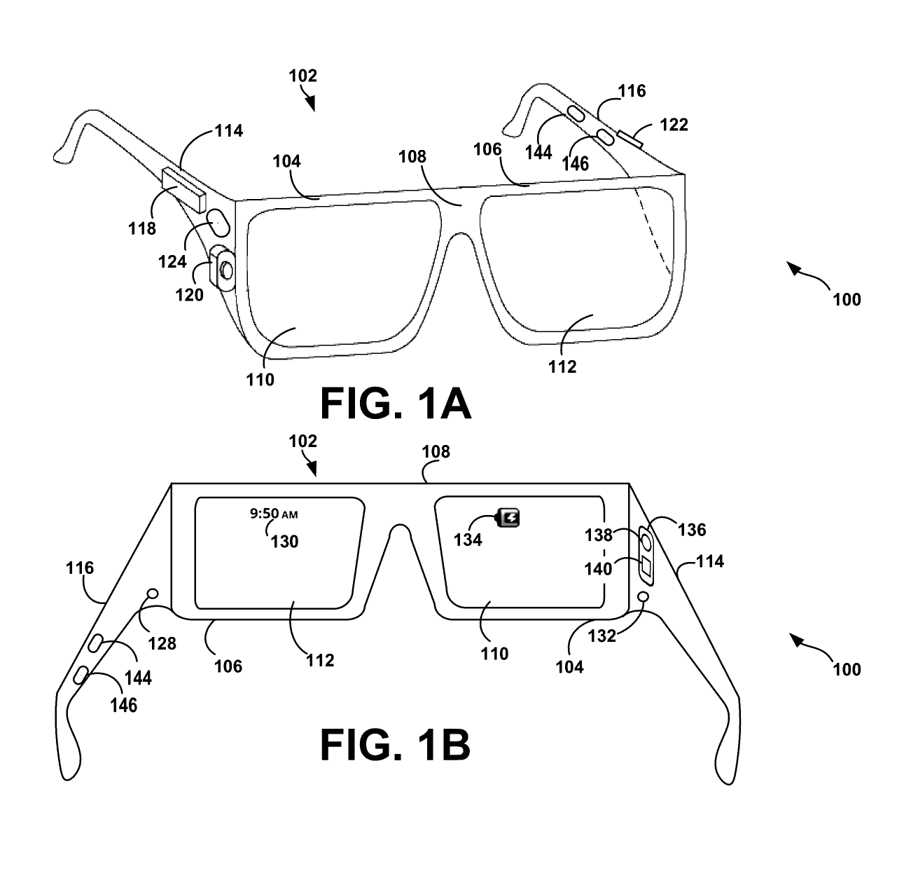

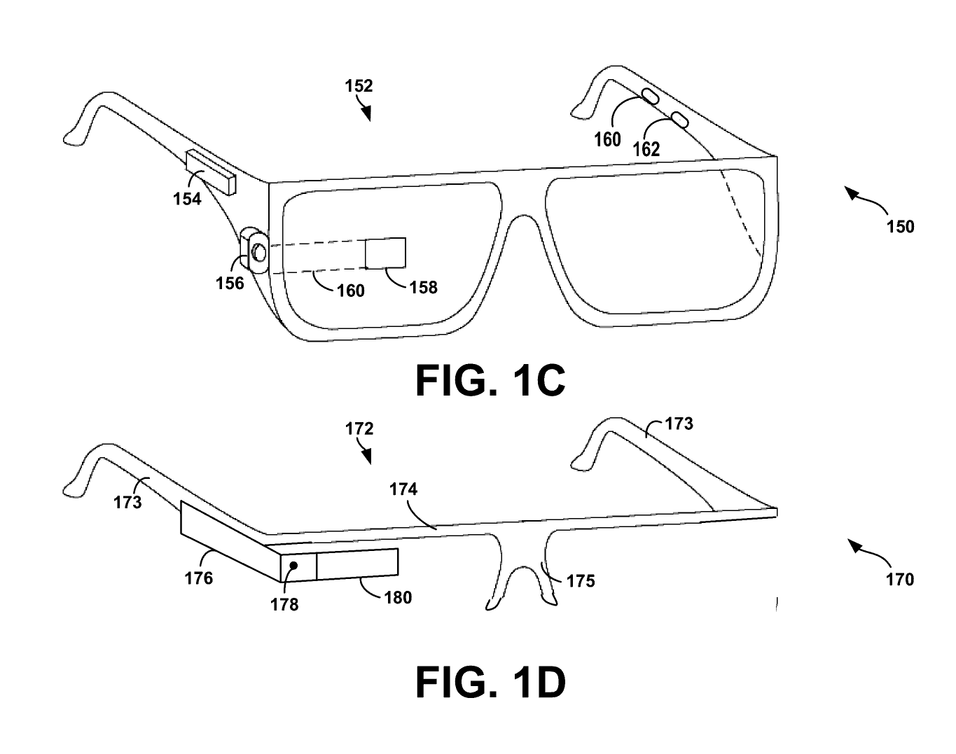

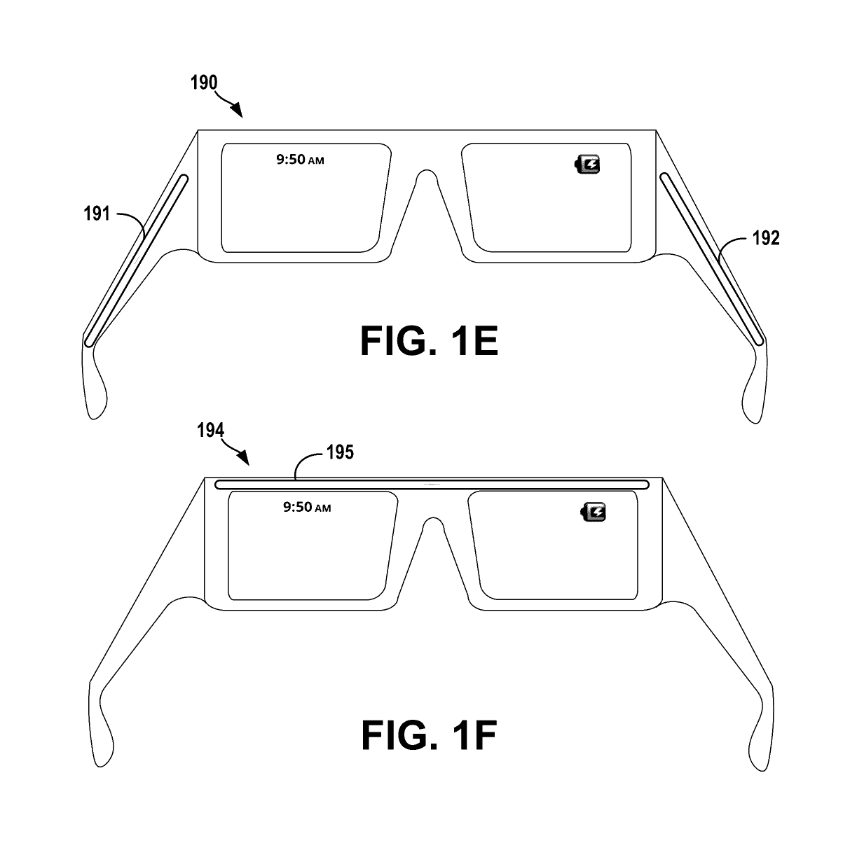

FIG. 1A illustrates an example of a wearable computing system 100. The wearable computing system 100 includes a proximity-sensing system 136 and an image-capturing system 120. While FIG. 1A illustrates a head-mountable device (HMD) 102 as an example of a wearable computing system, other types of wearable computing systems could be used. As illustrated in FIG. 1A, the HMD 102 includes frame elements, including lens frames 104, 106 and a center frame support 108, lens elements 110, 112, and extending side arms 114, 116. The center frame support 108 and the extending side arms 114, 116 are configured to secure the HMD 102 to a user's face via a user's nose and ears.

Each of the frame elements 104, 106, and 108 and the extending side arms 114, 116 can be formed of a solid structure of plastic and/or metal, or can be formed of a hollow structure of similar material so as to allow wiring and component interconnects to be internally routed through the HMD 102. Other materials can be used as well.

The lens elements 110, 112 can be formed of any material that can suitably display a projected image or graphic. Each of the lens elements 110, 112 can also be sufficiently transparent to allow a user to see through the lens element. Combining these two features of the lens elements can facilitate an augmented reality or heads-up display where the projected image or graphic is superimposed over a real-world view as perceived by the user through the lens elements.

The extending side arms 114, 116 can each be projections that extend away from the lens frames 104, 106, respectively, and can be positioned behind a user's ears to secure the HMD 102 to the user. The extending side arms 114, 116 can further secure the HMD 102 to the user by extending around a rear portion of the user's head. The wearable computing system 100 can also or instead connect to or be affixed within a head-mountable helmet structure.

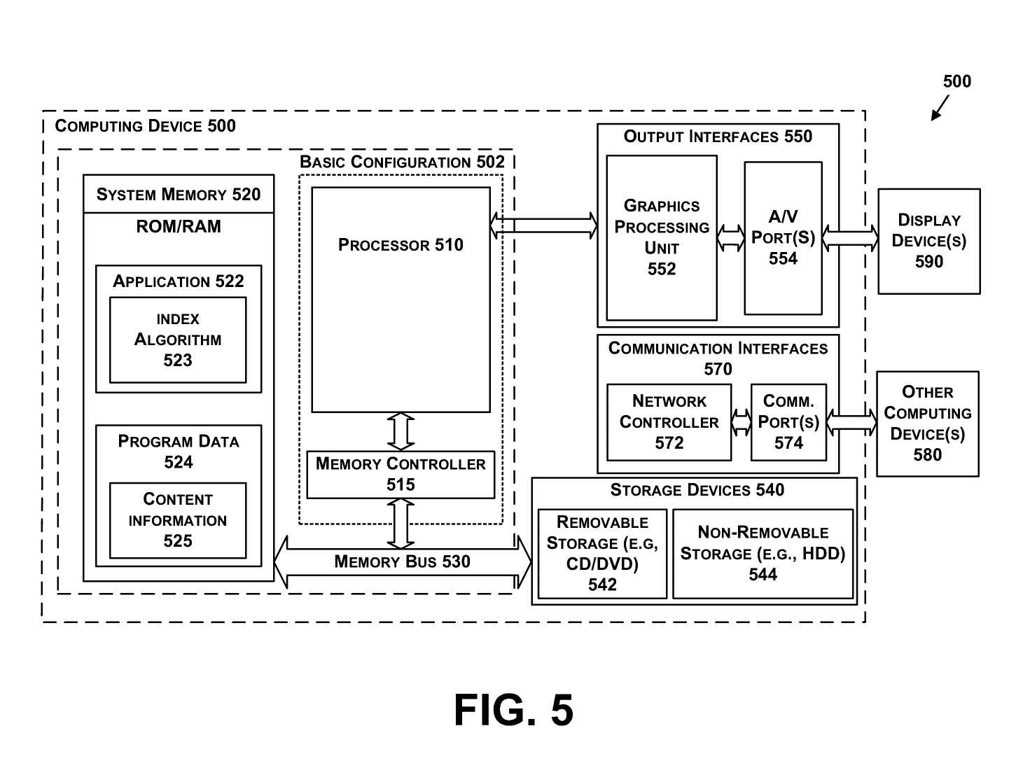

The HMD 102 can include an on-board computing system 118, a video camera 120, a sensor 122, and a finger-operable touch pad 124. The on-board computing system 118 is shown to be positioned on the extending side arm 114 of the HMD 102. The on-board computing system 118 can be provided on other parts of the HMD 102 or can be positioned remote from the HMD 102. For example, the on-board computing system 118 could be wire- or wirelessly-connected to the HMD 102. The on-board computing system 118 can include a processor and memory, for example. The on-board computing system 118 can be configured to receive and analyze data from the video camera 120 and the finger-operable touch pad 124 (and possibly from other sensory devices, user interfaces, or both) and generate images for output by the lens elements 110 and 112. The on-board computing system can take the form of the computing system 500, which is discussed below in connection with FIG. 5.

With continued reference to FIG. 1A, the video camera 120 is shown positioned on the extending side arm 114 of the HMD 102; however, the video camera 120 can be provided on other parts of the HMD 102. The video camera 120 can be configured to capture image data at various resolutions or at different frame rates. One or multiple video cameras with a small form factor, such as those used in cell phones or webcams, for example, can be incorporated into the HMD 102.

Further, although FIG. 1A illustrates one video camera 120, more video cameras can be used, and each can be configured to capture the same view, or to capture different views. For example, the video camera 120 can be forward facing to capture at least a portion of the real-world view perceived by the user. The image data captured by the video camera 120 can then be used to generate an augmented reality where computer generated images appear to interact with the real-world view perceived by the user.

The sensor 122 is shown on the extending side arm 116 of the HMD 102; however, the sensor 122 can be positioned on other parts of the HMD 102. The sensor 122 can include one or more of a gyroscope, an accelerometer, or a proximity sensor, for example. Other sensing devices can be included within, or in addition to, the sensor 122 or other sensing functions can be performed by the sensor 122.

The finger-operable touch pad 124 is shown on the extending side arm 114 of the HMD 102. However, the finger-operable touch pad 124 can be positioned on other parts of the HMD 102. Also, more than one finger-operable touch pad can be present on the HMD 102. The finger-operable touch pad 124 can be used by a user to input commands. The finger-operable touch pad 124 can sense at least one of a position and a movement of a finger via capacitive sensing, resistance sensing, or a surface acoustic wave process, among other possibilities. The finger-operable touch pad 124 can be capable of sensing finger movement in a direction parallel or planar to the pad surface, in a direction normal to the pad surface, or both, and can also be capable of sensing a level of pressure applied to the pad surface. The finger-operable touch pad 124 can be formed of one or more translucent or transparent insulating layers and one or more translucent or transparent conducting layers. Edges of the finger-operable touch pad 124 can be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad can be operated independently, and can provide a different function.

As shown, the HMD 102 also includes capacitive sensors 144, 146. The capacitive sensors 144, 146 may be formed of, for example, copper. Other materials are possible as well. The capacitive sensors 144, 146 are shown to be positioned on the extending side-arm 116 of the HMD 102; however, the capacitive sensors 144, 146 may be provided on other parts of the HMD 102 as well. Further, while two capacitive sensors 144, 146 are shown, more or fewer capacitive sensors 144, 146 are possible as well. Each of the capacitive sensors 144, 146 may be configured to sense a capacitance between the capacitive sensor and a surrounding medium, such as air and/or a nearby conductor, such as a head of a user, as well as a capacitance between the capacitive sensor and a “ground,” such as a nonconducting portion of the HMD.

FIG. 1B illustrates an alternate view of the wearable computing system 100 illustrated in FIG. 1A. As shown in FIG. 1B, the lens elements 110, 112 can act as display elements. The HMD 102 can include a first projector 128 coupled to an inside surface of the extending side arm 116 and configured to project a display 130 onto an inside surface of the lens element 112. A second projector 132 can be coupled to an inside surface of the extending side arm 114 and can be configured to project a display 134 onto an inside surface of the lens element 110.

The lens elements 110, 112 can act as a combiner in a light projection system and can include a coating that reflects the light projected onto them from the projectors 128, 132. In some embodiments, a reflective coating may not be used (such as, for example, when the projectors 128, 132 are scanning laser devices).

In some embodiments, other types of display elements can also be used. For example, the lens elements 110, 112 themselves can include one or more transparent or semi-transparent matrix displays (such as an electroluminescent display or a liquid crystal display), one or more waveguides for delivering an image to the user's eyes, or one or more other optical elements capable of delivering an in focus near-to-eye image to the user. A corresponding display driver can be disposed within the frame elements 104, 106 for driving such a matrix display. Alternatively or additionally, a laser or LED source and scanning system could be used to draw a raster display directly onto the retina of one or more of the user's eyes.

The proximity-sensing system 136 includes a light source 138 and a light sensor 140 affixed to the extending side arm 114 of the HMD 102. The proximity-sensing system 136 can include elements other than those shown in FIG. 1B. Additionally, the proximity-sensing system 136 can be arranged in other ways. For example, the light source 138 can be mounted separately from the light sensor 140. As another example, the proximity-sensing system 136 can be mounted to other frame elements of the HMD 102, such as, for example, to the lens frames 104 or 106, to the center frame support 108, or to the extending side arm 116.

FIG. 1C illustrates another example of a wearable computing system 150. The wearable computing system 150 includes an image-capturing system 156. The wearable computing system 150 can be coupled to a proximity-sensing system, although a proximity-sensing system is not shown in FIG. 1C. While FIG. 1C illustrates an HMD 152 as an example of a wearable computing system, other types of wearable computing systems could be used. The HMD 152 can include frame elements and side arms such as those discussed above in connection with FIGS. 1A and 1B. The HMD 152 can also include an on-board computing system 154 and a video camera 156, such as those discussed above in connection with FIGS. 1A and 1B. The video camera 156 is shown to be mounted on a frame of the HMD 152; however, the video camera 156 can be mounted at other positions as well.

As shown in FIG. 1C, the HMD 152 can include a single display 158, which can be coupled to the HMD. The display 158 can be formed on one of the lens elements of the HMD 152, such as a lens element having a configuration as discussed above in connection with FIGS. 1A and 1B. The display 158 can be configured to overlay computer-generated graphics in the user's view of the physical world. The display 158 is shown to be provided in a center of a lens of the HMD 152; however, the display 158 can be provided in other positions. The display 158 is controllable via the computing system 154, which is coupled to the display 158 via an optical waveguide 160.

As further shown in FIG. 1C, the HMD 152 includes two capacitive sensors 160, 162. The capacitive sensors 160, 162 are shown mounted on a sidearm of the HMD 152. However, the capacitive sensors 160, 162 may be mounted at other positions as well. Further, while two capacitive sensors 160, 162 are shown, more or fewer capacitive sensors are possible as well. The capacitive sensors 160, 162 may take any of the forms described above in connection with FIGS. 1A and 1B.

FIG. 1D illustrates another example of a wearable computing system 170. The wearable computing system 170 can include an image-capturing system 178 and a proximity-sensing system (not shown in FIG. 1D). The wearable computing system 170 is shown in the form of an HMD 172; however, the wearable computing system 170 can take other forms as well. The HMD 172 can include side arms 173, a center frame support 174, and a bridge portion with a nosepiece 175. In the example shown in FIG. 1D, the center frame support 174 connects the side arms 173. The HMD 172 does not include lens-frames containing lens elements. The HMD 172 can also include an on-board computing system 176 and a video camera 178, such as those discussed above in connection with FIGS. 1A and 1B.

The HMD 172 can include a single lens element 180, which can be coupled to one of the side arms 173 or to the center frame support 174. The lens element 180 can include a display, such as the display discussed above in connection with FIGS. 1A and 1B. The lens element 180 can be configured to overlay computer-generated graphics upon the user's view of the physical world. In an example, the single lens element 180 can be coupled to the inner side (the side exposed to a portion of a user's head when worn by the user) of the extending side arm 173. The single lens element 180 can be positioned in front of or proximate to a user's eye when the user wears the HMD 172. For example, the single lens element 180 can be positioned below the center frame support 174, as shown in FIG. 1D.

The HMD 172 may include two capacitive sensors (not shown). The capacitive sensors may be mounted on a sidearm of the HMD 170. However, the capacitive sensors 182,184 may be mounted at other positions as well. More or fewer capacitive sensors are possible as well. The capacitive sensors may take any of the forms described above in connection with FIGS. 1A and 1B.

FIG. 1E illustrates a HMD 190, in accordance with yet another example embodiment. As shown in FIG. 1E, the HMD 190 includes a capacitive sensor 191 on one sidearm of the HMD and another capacitive sensor 192 on another sidearm of the HMD. Placing the capacitive sensors 191, 192 on opposite sidearms may improve an ability of the HMD to reject false positives and/or negatives when making comparisons between a sensed capacitance and a reference capacitance, as described above. While each of the capacitive sensors 191, 192 is shown to extend across most of the sidearm, in other embodiments the capacitive sensors 191, 192 may extend across more of less of the sidearms.

FIG. 1F illustrates a HMD 194, in accordance with yet another example embodiment. As shown in FIG. 1F, the HMD 194 includes a capacitive sensor 195. The capacitive sensor 195 is shown to extend across a frame element of the HMD device 194. While the capacitive sensor 195 is shown to extend across most of the frame element, in other embodiments the capacitive sensor 195 may extend across more of less of the frame element. Further, in some embodiments, two or more capacitive sensors may be used, such as one capacitive sensor extending along the frame element above each lens element. Other examples are possible as well.

The HMD device may take other forms as well.

b. Proximity-Sensing System

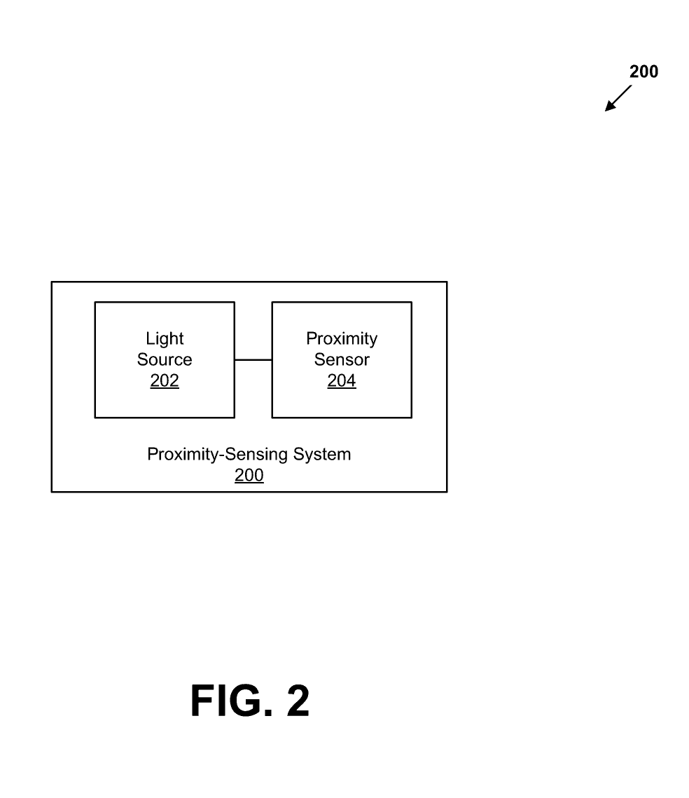

FIG. 2 illustrates a proximity-sensing system 200. The proximity-sensing system 200 includes a light source 202 and a proximity sensor 204. The light source 202 and the proximity sensor 204 can be connected to an HMD, such as one of the HMDs discussed above in section I (a).

For ease of explanation, FIG. 2 shows a single light source and a single proximity sensor; the proximity-sensing system 200 can include more than one light source and more than one proximity sensor. In the proximity-sensing system 200, each of the light sources and proximity sensors can be arranged in any suitable manner so long as the proximity-sensing system is able to accomplish the disclosed functionality.

In operation, when the HMD is worn, the light source 202 provides light to an eye area of the HMD's wearer. The proximity sensor 204 receives light that is reflected from the eye area and, in response, generates data that represents a measurable change corresponding to a change in a characteristic of the received light.

The term “eye area,” as used in this disclosure, refers to an observable area of a human eye, an observable area near the eye, or both. To this end, the eye area can include a peripheral eye area, an interior eye area, an area near the eye, or a combination of these. Examples of peripheral eye areas include the eye's sclera, cornea, and limbus. An example of an interior area of the eye is the eye's iris. And examples of areas near the eye include the eyelids, other skin near the eye, and eyelashes.

The term “reflected,” as used in this disclosure in connection with an eye area, refers to a variety of interactions between light and the eye area, including those interactions that direct the light away from the eye area. Example of such interactions include mirror reflection, diffuse reflection, and refraction, among other light scattering processes.

A. Light Source

The light source 202 can include any suitable device or combination of devices that is capable of providing light. To this end, the light source 202 can include one or more devices such as a light emitting diode, a laser diode, an incandescent source, a gas discharge source, or a combination of these, among others.

In operation, the light source 202 can emit any suitable form of light. The light can be in the human visible range or outside that range. For example, the light can be near-infrared light. Note that infrared light and other forms of light outside the human visible range can be transmitted to an eye area of an HMD's wearer without potentially irritating the HMD's wearer. For ease of explanation, several examples in this disclosure discuss light in the infrared range.

The light source 202 can provide light to an entire eye area or to a portion of the eye area. The size of the eye area to which the light source 202 provides light is termed the “spot size.” For example, the light source 202 can provide light such that the spot size covers at least a portion of the upper eyelid both when the eye is in an open state and when it is in a closed state. As another example, the light source 202 can provide light such that the spot size covers at least a portion of the eye's cornea when the eye is oriented in a forward-facing direction, and such that the spot size covers at least a portion of the eye's sclera when the eye is oriented in another direction.

When the proximity-sensing system 200 includes multiple light sources, the light sources can differ in the spot sizes of the light they provide. For example, one light source can provide light with a spot size that covers the entire eye area, whereas another light source can provide light with a spot size that covers just a portion of the eye area. In other words, one light source can provide light to the entire eye area, and another light source can provide light to a portion of the eye area.

In an implementation, the light source 202 can use modulated or pulsed light. Doing so can help to distinguish light provided by the light source 202 not only from ambient light, but also from light provided by another light source (when there are multiple light sources). Note that the light source 202 can use another light characteristic to distinguish the light it emits from other types of light; examples of light characteristics include frequency and light intensity.

B. Proximity Sensor

The proximity sensor 204 can include any suitable device or combination of devices that is capable of receiving light and, in response, generating data that represents a measurable change corresponding to a change in a characteristic of the received light. To this end, the proximity sensor 204 can include one or more devices such as a photodiode, an electro-optical sensor, a fiber-optic sensor, a photo-detector, or a combination of these, among others.

The proximity sensor 204 can be positioned in a way that permits it to detect light that is reflected from certain portions of an eye area. For example, the proximity sensor 204 can be positioned above an eye. So positioned, the proximity sensor 204 can detect light that is reflected from the top of the eye when the eye is open, and can detect light that is reflected from the top eyelid when the eye is closed. As another example, the proximity sensor 204 can be positioned at an oblique angle with respect to the eye area. For instance, the proximity sensor 204 can be positioned similar to the sensor 140 shown in FIG. 1B. As another example, the proximity sensor 204 can be positioned so that it can focus on the center of the eye area.

In operation, when the proximity sensor 204 receives light, the proximity sensor 204 can generate data that is indicative of the received light. In an implementation, the data represents intensity of the received light as a function of time. The proximity sensor 204 can generate data that represents another characteristic of the received light. For example, the data can represent characteristics of the received light such as frequency, polarization, coherence, phase, spectral width, modulation, or a combination of these, among other characteristics.

When the proximity-sensing system 200 includes multiple light sources, the generated data can take various forms. For example, the proximity sensor 204 or another system can combine received light from all of the light sources in a way that a single curve represents the combined light. As another example, the generated data from the proximity sensor 204 can include separate data sets, with each data set representing light from a separate light source.

Like the light source 202, the proximity sensor 204 can operate in connection with any suitable form of light, whether that light is in the human visible range or outside that range. In addition, the proximity sensor 204 or another system can perform calibrations based on the received light. For example, when the light source 202 and the proximity sensor 204 operate on a common frequency range of light, such as infrared light, the proximity sensor 204 or another system can filter out light that is not in that range. This can reduce noise in the data that the proximity sensor 204 generates. As another example, when the proximity sensor 204 receives light with relatively low intensity levels, the proximity sensor 204 or another system can adjust the sensitivity of the proximity sensor 204.

The proximity sensor 204 can operate in connection with light frequencies and intensities in various ways. In an implementation, the proximity sensor 204 operates on a specified range of frequencies or intensities to the exclusion of frequencies or intensities that are outside that range. In another implementation, the proximity sensor 204 has a granularity that is higher for a specified range of frequencies or intensities than for frequencies or intensities that are outside that range.

Of course, when the light source 202 uses modulated or pulsed light, the proximity sensor 204 not only can receive the modulated or pulsed light, but also can distinguish the modulated or pulsed light from other types of light.

### III. EXAMPLE METHODS

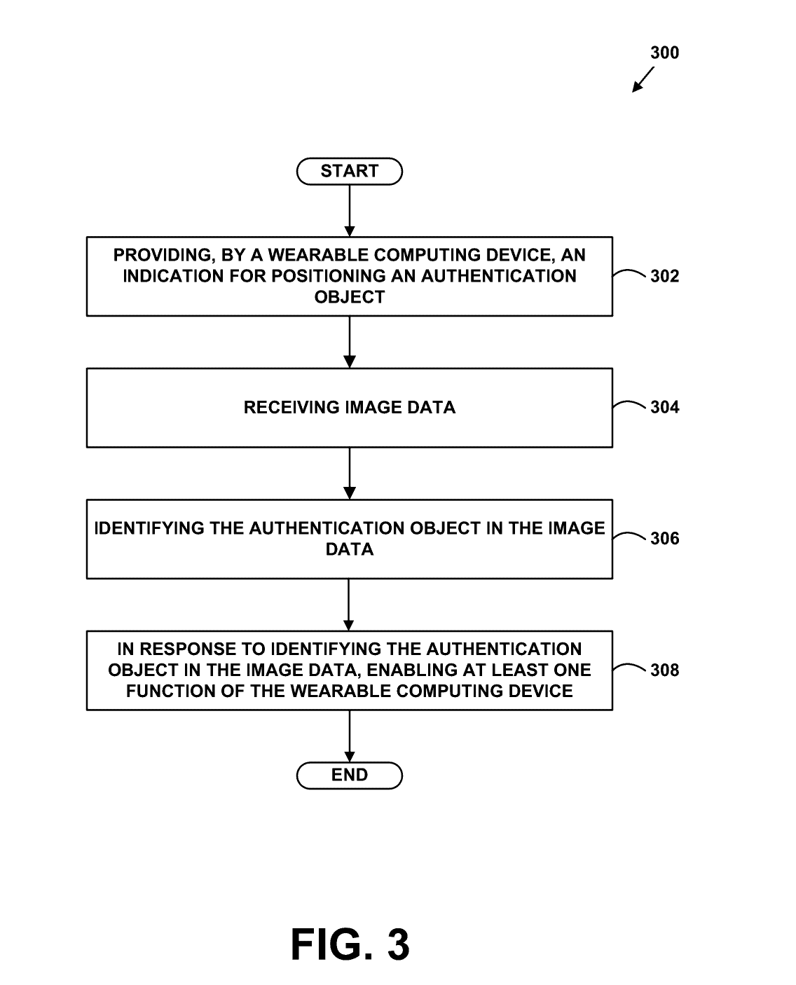

FIG. 3 is a block diagram of an example method for biometric based authentication for a HMD. Method 300 shown in FIG. 3 presents an embodiment of a method that, for example, may be performed by a device the same as or similar to any of the devices depicted in FIGS. 1A-1F. Method 300 may include one or more operations, functions, or actions as illustrated by one or more of blocks 302-308. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 300 and other processes and methods disclosed herein, the flowchart shows functionality and operation of one possible implementation of present embodiments. In this regard, each block may represent a module, a segment, or a portion of program code, which includes one or more instructions executable by a processor or computing device for implementing specific logical functions or steps in the process. The program code may be stored on any type of computer readable medium or memory, for example, such as a storage device including a disk or hard drive. The computer readable medium may include non-transitory computer readable media, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, or compact-disc read only memory (CD-ROM), for example. The computer readable media may also be any other volatile or non-volatile storage systems. The computer readable medium may be considered a computer readable storage medium, for example, or a tangible storage device.

In addition, for the method 300 and other processes and methods disclosed herein, each block in FIG. 3 may represent circuitry that is wired to perform the specific logical functions in the process.

Initially, at block 302, method 300 includes providing, by a wearable computing device, an indication for positioning an authentication object within a field of view of an image capture device. The wearable computing device may take the form of an HMD the same as or similar to the one discussed with reference to FIGS. 1A, for example, and the image capture device may be the same as or similar to camera 120. Other image devices may be used. The field of view of the image capture device may be a field of view associated with camera 120, and may be defined by lens elements 110, 112, for example.

The indication for positioning an authentication object within a field of view of the image capture device may be any indication sufficient to guide the user of the wearable computing device to correctly position the authentication object. In one example, the indication may be a graphical outline within which the authentication object is to be positioned. The graphical outline may be displayed on a lens of the wearable computing device for example, and may be depicted in various forms such as a dotted line, a colored line, or multiple lines, to name a few. In some examples, the graphical outline may take the shape of the authentication object. In other examples, the graphical outline may be a different or basic shape such as a square or circle. Alternatively, the indication may be a graphical image over which the authentication object is to be positioned. The graphical image may take the shape of the authenticating object or may be a different shape. In even further examples, the indication may simply be text indicating a general area in which the authentication object should be placed. Other indications are possible as well.

In some examples, the wearable computing may receive or obtain video data indicative of a field of view associated with the wearable computing device. Based on the video data, the wearable computing device may display a video feed that may also include the indication for positioning the authentication object. The indication in the video feed may take the form of any of the various examples discussed above.

The authentication object may be any object with distinct and measurable characteristics that may be used to confirm the identity of a specific user (individual) of the wearable computing device. In some examples, the authentication object may include body parts of the user. For example, the authentication object may be a hand of the specific user. In other examples, the authentication object may include a fingerprint of the specific user, a hair follicle of the specific user, microstructure from the skin of the specific user, or a face of the specific user. Other authentications objects are possible and may, or may not, be a body part. In some examples the biometric information may be stored in the form of a token or other object that may be examined in a similar fashion as a body part.

In one particular example (herein after referred to as the “hand-recognition example”), a user may operate HMD 102 discussed with reference to FIGS. 1A and 1B. Initially, the HMD 102 may be in a locked state. In the locked state the HMD 102 may be operable only to perform the authenticating process as described currently with reference to method 300, thereby preventing the user from utilizing or accessing most of the functionality of the HMD 102.

To begin the authentication process, the user may don (place the HMD on his/her head) the HMD 102, and upon donning the HMD, the HMD 102 may thereafter recognize that the HMD is donned using capacitors 144 and 146, for example. To do so the capacitors 144 and 146 may sense a capacitance when the user dons the HMD 102. In other examples the HMD 102 may recognize the user donned the HMD using proximity sensor 136, for example. Regardless of the manner in which the HMD is donned, once the HMD recognizes it has been donned, the user may begin the authentication process.

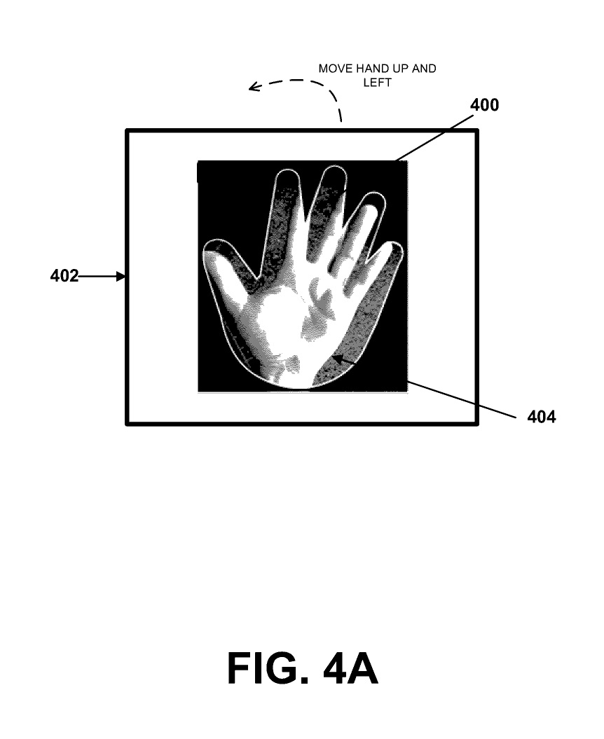

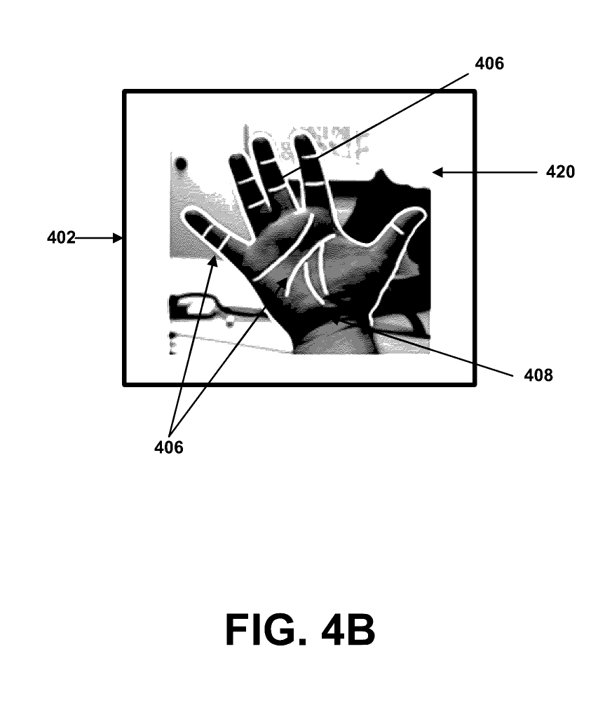

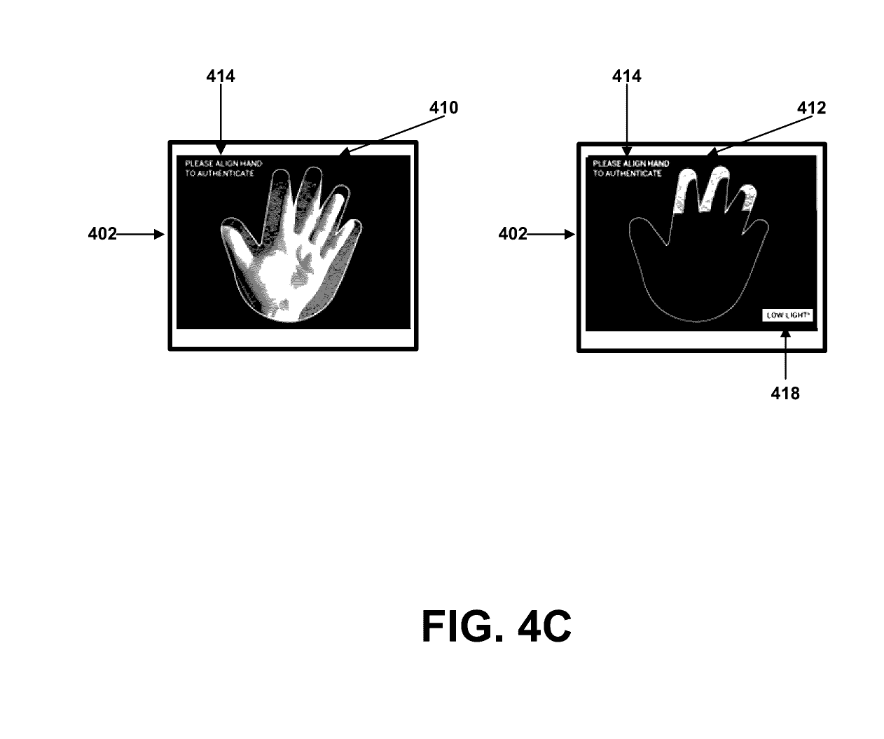

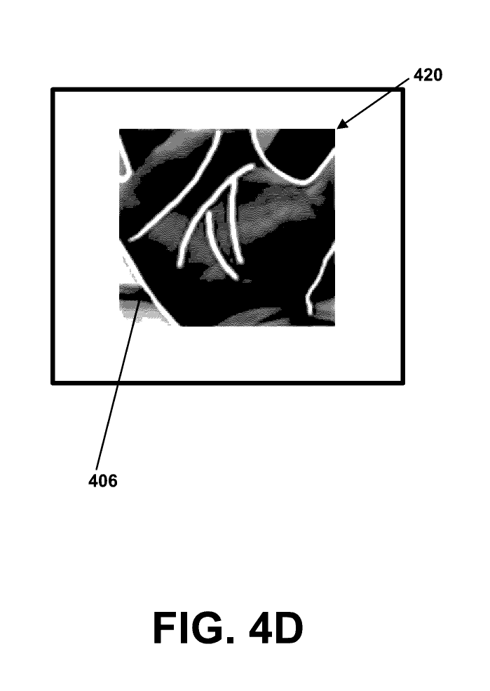

When the authentication process starts, the user may be provided with the indication for positioning an authentication object. In some examples, the indication may be provided in response to donning the HMD. In this particular hand-recognition example, the indication may include a graphical image depicting an outline of a hand, as shown in FIG. 4A, for example. FIG. 4A illustrates an outline of a hand 400 displayed within the field of view 402 of camera 120.

After the indication for positioning an authentication object has been provided, method 300, at block 304, includes receiving image data from the image capture device. As aforementioned, the image capture device may be a camera similar to those discussed with reference to FIGS. 1A-1F, for example, but need not be. Other image capture devices are possible. To receive the image data, the wearable computing device may cause the image capture device to take a picture. For instance, in one example, a user of HMD 170 (shown in FIG. 1D) may wink causing the HMD 170 to cause the camera 178 to take a picture. The wink may be recognized, for example, using a proximity-sensing system as shown in FIG. 2. Other triggering actions may be used to trigger the wearable computing device to acquire image data.

As used in this disclosure, the term “image data” can refer to various types of data; the meaning of the term “image data” can depend on the context in which the term is used. In some contexts, the term “image data” can refer to a raw image file (or to multiple raw image files). The raw image file can represent unprocessed or minimally processed data from an image sensor of a camera, such as a digital camera or an image scanner, among other types. Examples of raw images files include camera image file format (CIFF) and digital negative (DNG). Note that this disclosure contemplates any other suitable type of raw image file. In some contexts, the term “image data” can refer to data in a format that can be rasterized for use on a display; examples include RAW images, Portable Network Graphics (PNG) images, Joint-Photographic Experts Group (JPEG) compressed images, Bitmap (BMP) images, and Graphics Interchange Format (GIF) images, among various other types. In some contexts, the term “image data” can refer to data in a vector format, such as, for example, an eXtensible Markup Language (XML) based file format; an example includes Scalable Vector Graphics (SVG), among other types. In some contexts, the term “image data” can refer to data that is in a graphics pipeline along a rendering device, such as a graphics processing unit (GPU) or a central processing unit (CPU), among others. In some contexts, the term “image data” can refer to data that is stored in a display's video memory (such as, for example, random access memory (RAM)) or in graphics card. In some contexts, the term “image data” can refer to data that includes light-field information, such as, for example, four-dimensional (4D) light-field information. In this example, the data can represent raw data that is captured by, for example, a plenoptic camera (sometimes termed a “light-field camera”), or the data can represent a processed version of such raw data. Note that the term “image data” can encompass various types of data, can be of various file formats, and can be stored to various mediums, whether those types of data, file formats, and mediums are known or have yet to be developed.

The image data can be, but need not be, data that was captured by a camera. Accordingly, the image capture device can be, but need not, be a camera. As an example, the image data can represent a still image of an already captured video, whether the still image is in the same file format as the video or in a different file format from the video. In this example, the image capture device includes any combination of the hardware, firmware, and software that is used to generate the still image from the frame of the video. Of course, in this example, the image data can represent multiple still images of the video. As another example, the image data can represent a screenshot of a display. These examples are illustrative only; image data can be captured in various other ways.

In further examples, the wearable computing device may also receive video data indicative of the field of view associated with the camera. The video data may be acquired in a manner the same as or similar to that of the image data (e.g., a user winks to obtain video data).

Continuing with the hand-recognition authentication example, once the user has been provided with the outline of the hand, the user may position his/her hand 404 accordingly so that it appears within the outline of the hand 404 also shown in FIG. 4A, for example. In FIG. 4A, the hand 404 is in the process of being positioned in the indication outline as illustrated by the dotted lines. In this example, the hand 404 needs to be positioned slightly up and slightly to the left.

In some examples, to facilitate/ensure that the user has appropriately positioned his/her hand, the computer system 118 of the HMD 102 may, for example, detect when the hand of the user has been placed within the indication, or in this case, within the outline of the hand using computer vision techniques such as template matching, histogram of gradients, or the Scale-invariant feature transform algorithm, to name a few. Once the hand has been detected, the HMD 102 may change the formatting of the outline (indication for positioning the authentication object) to indicate the appropriate positioning of the hand. In one example, the color of the outline may be changed to yellow signaling to the user that the hand has been detected (not shown).

Once the hand has been detected, the HMD 102 may ensure that the image data is clear enough to be used for authentication. To do so, the computing device 118 of HMD 102 may, for example, utilize various edge detector algorithms (using operators such as Canny, Prewitt or Sobel, for example) on the image data to create a detailed outline of the hand (different than the previously described indication outline), and thereafter superimpose the outline of the hand on the HMD signaling to the user that the image data is sufficient (i.e., the HMD recognizes the hand sufficiently). An example of how the outline may be superimposed on the hand is shown in FIG. 4B. In FIG. 4B the hand 408 is shown with line highlights 406 that, taken together, create the detailed outline of the hand 408. Other techniques are possible to create an outline of the hand, and the outline may be shown in other manners than that of FIG. 4B. In other examples instead of creating a new outline of the hand 408, the original indication 400 may be changed again. For example, if the image data is sufficient, the indication may be changed to green.

In examples in which the HMD 102 receives video data, the HMD may determine whether the video data is sufficient in a similar fashion as that of the image data.

If the image data is sufficiently clear, the computing system 118 may proceed with authentication. If, however, the image data is not sufficiently clear, the HMD 102 may provide the user with further instructions on how to proceed. For example, if the computing system 118 of the HMD 102 determines that there is not enough light to obtain sufficient image data, the HMD 102 may superimpose imagery on a display of the HMD 102 indicating as such, as shown for example in FIG. 4C. FIG. 4C illustrates two examples of superimposed imagery providing instructions to the user. In image data 410 superimposed imagery 416 instructs the user to “Please Align Hand To Authenticate,” and in image data 412 superimposed imagery instructs the user to “Please Align Hand To Authenticate,” and indicates using superimposed imagery 418 that there is “Low Light!” where the user is currently attempting to acquire the image data. Any instruction may be provided to the user to help guide the user in obtaining sufficient image data. The same or similar instructions may be provided to the user when obtaining video data as well.

After accurately positioning his/her hand the user may wink and cause, using the proximity sensor 136, the HMD 102 to acquire image data indicative of the hand. Other triggering methods are possible and contemplated herein. In this instance, when the user winks, the camera 120 of the HMD 102 may take a picture of the hand of the user, for example, shown in FIG. 4B. In FIG. 4B the image data 420 is shown with the outline 406, however in some cases the image data 420 may be captured without the outline.

In some embodiments, after the image data is received and the authentication object has been identified, the image data may not be used immediately, but instead the image data may be saved and used at a later time. In this regard, the foregoing processes may be used to enroll a new user of the HMD. For example, a new user of the HMD may enroll the HMD by donning the HMD in a manner similar to that discussed above with regard to the hand-recognition example, and obtaining image data of an authentication object using a process similar to that discussed above. In some examples, a backup PIN may be provided by the user to allow the user to restart the enrollment process or in situations when the image data of the authentication object cannot be used to authenticate the HMD (e.g., if the handprint or palmprint of the user changes). Once the user has been enrolled, the user may authenticate the HMD in a manner similar to steps 306 and 308, discussed below, at a later and desired time.

Once the image data has been received, method 300, at block 306, includes identifying the authentication object in the image data. To do so, the wearable computing device may, for example, select a portion of the image data and compare the selected portion of the image data to a data profile representing the authenticating object. Based on the comparison, the wearable computing device may determine a match between the selected portion of the image data and at least a portion of the data profile. The data profile of the authenticating object may be any data used to verify the authenticity of the object. In examples in which the authenticating object is a hand of a particular individual, the data profile may represent data that defines the hand of the particular individual. For instance, the data profile may include one or more of a handprint of the specific individual, a plurality of static-gesture images indicative of a gesture of the hand of the specific individual, or a plurality of motion-gesture images indicative of a motion of the hand of the specific individual. In examples in which the authenticating object is something other than a hand, the data profile may include various characteristics that define that corresponding object.

Referring back to the hand-recognition example, the HMD 102 may process the captured image 420 of the hand (shown in FIGS. 4B and 4D). To do so, the wearable computing device may, for example, select a portion of the image data based on the outline, as shown in FIG. 4D. For instance, the HMD may select only the palm-portion of the hand within the outline. Using this selected portion, the HMD may compare the selected portion of the image data to a data profile. In this example, the data profile of the hand may include a palm print of a specific individual. Based on the palm print, the HMD 102 may detect a match between the selected portion of the image data and at least a portion the palm print.

In response to determining a match, method 300, at block 308, includes enabling at least one function of the wearable computing device. The function may include enabling any of the functionality described with reference to FIGS. 1A-1F, for example. If no match is determined the HMD may remain in the initial locked state. In other examples, when no match is determined, the process to authenticate the HMD may be repeated. In further examples, the HMD may provide alternative authenticating means or back-up authenticating means by, for example, providing the user with a prompt to enter a PIN or password. In yet even further examples, the user may be prompted with the PIN or password to restart the authenticating process.

### IV. COMPUTING DEVICE

FIG. 5 illustrates a functional block diagram of an example of a computing device 500. The computing device 500 can be used to perform any of the functions discussed in this disclosure, including those functions discussed above in connection with FIGS. 3A and 3B and FIGS. 4A-4D. In an implementation, the computing device 500 can be implemented as a portion of a head-mountable device, such as, for example, any of the HMDs discussed above in connection with FIGS. 1A-1F. In another implementation, the computing device 500 can be implemented as a portion of a small-form factor portable (or mobile) electronic device that is capable of communicating with an HMD; examples of such devices include a cell phone, a personal data assistant (PDA), a personal media player device, a wireless web-watch device, an application specific device, or a hybrid device that include any of the above functions. In another implementation, the computing device 510 can be implemented as a portion of a computer, such as, for example, a personal computer, a server, or a laptop, among others.

In a basic configuration 502, the computing device 500 can include one or more processors 510 and system memory 520. A memory bus 530 can be used for communicating between the processor 510 and the system memory 520. Depending on the desired configuration, the processor 510 can be of any type, including a microprocessor (μP), a microcontroller (μC), or a digital signal processor (DSP), among others. A memory controller 515 can also be used with the processor 510, or in some implementations, the memory controller 515 can be an internal part of the processor 510.

Depending on the desired configuration, the system memory 520 can be of any type, including volatile memory (such as RAM) and non-volatile memory (such as ROM, flash memory). The system memory 520 can include one or more applications 522 and program data 524. The application(s) 522 can include an index algorithm 523 that is arranged to provide inputs to the electronic circuits. The program data 524 can include content information 525 that can be directed to any number of types of data. The application 522 can be arranged to operate with the program data 524 on an operating system.

The computing device 500 can have additional features or functionality, and additional interfaces to facilitate communication between the basic configuration 502 and any devices and interfaces. For example, data storage devices 540 can be provided including removable storage devices 542, non-removable storage devices 544, or both. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives. Computer storage media can include volatile and nonvolatile, non-transitory, removable and non-removable media implemented in any method or technology for storage of information, such as computer readable instructions, data structures, program modules, or other data.

The system memory 520 and the storage devices 540 are examples of computer storage media. Computer storage media includes, but is not limited to, RAM, ROM, EEPROM, flash memory or other memory technology, CD-ROM, DVDs or other optical storage, magnetic cassettes, magnetic tape, magnetic disk storage or other magnetic storage devices, or any other medium that can be used to store the desired information and that can be accessed by the computing device 500.

The computing device 500 can also include output interfaces 550 that can include a graphics processing unit 552, which can be configured to communicate with various external devices, such as display devices 590 or speakers by way of one or more A/V ports or a communication interface 570. The communication interface 570 can include a network controller 572, which can be arranged to facilitate communication with one or more other computing devices 580 over a network communication by way of one or more communication ports 574. The communication connection is one example of a communication media. Communication media can be embodied by computer-readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR), and other wireless media.

In come configurations the computing device 500 can also include capacitive sensors (not shown) configured to sense a capacitance of a surrounding medium, such as air and/or a nearby conductor, such as a head of a user. The capacitive sensors may take any of the forms described above in connection with the capacitive sensors shown in FIGS. 1A-1F.

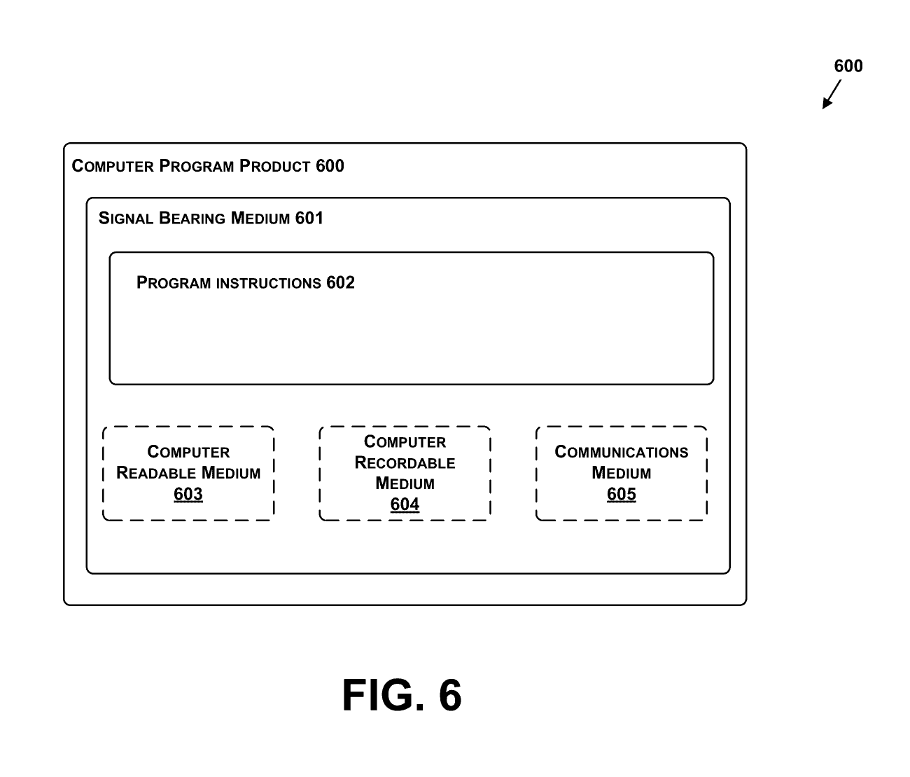

The disclosed methods can be implemented as computer program instructions encoded on a non-transitory computer-readable storage medium in a machine-readable format, or on other non-transitory media or articles of manufacture. FIG. 6 illustrates a conceptual example of a computer program product 600 that includes a computer program for executing a computer process on a computing device.

The computer program product 600 is provided using a signal bearing medium 601. The signal bearing medium 601 can include one or more programming instructions 602 that, when executed by one or more processors, can provide functionality or portions of the functionality discussed above. In some implementations, the signal bearing medium 601 can encompass a computer-readable medium 603 such as, but not limited to, a hard disk drive, a CD, a DVD, a digital tape, or memory. In some implementations, the signal bearing medium 601 can encompass a computer-recordable medium 604 such as, but not limited to, memory, read/write (R/W) CDs, or R/W DVDs. In some implementations, the signal bearing medium 601 can encompass a communications medium 605 such as, but not limited to, a digital or analog communication medium (for example, a fiber optic cable, a waveguide, a wired communications link, or a wireless communication link). Thus, for example, the signal bearing medium 601 can be conveyed by a wireless form of the communications medium 605 (for example, a wireless communications medium conforming with the IEEE 802.5 standard or other transmission protocol).

### IV. CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method comprising:
providing, by a wearable computing device, an indication for positioning a hand within a field of view of an image capture device, wherein the wearable computing device comprises a head mountable display (HMD) and the image capture device;
receiving image data indicative of the field of view of the image capture device;
identifying the hand in the image data;
determining that the image data includes palmprint lines in the hand that provide sufficient detail for use as input to a subsequent authentication process that determines whether or not the palmprint lines match a data profile corresponding to a specific individual;
in response to determining that the image data includes palmprint lines in the hand that provide sufficient detail for use as input to the subsequent authentication process, (i) generating a graphic image of the palmprint lines and (ii) displaying, in a display of the HMD, the image data of the hand and the graphic image of the palmprint lines, wherein the graphic image of the palmprint lines is superimposed on the palmprint lines in the hand; and
detecting a match between the palmprint lines in the hand and the data profile corresponding to the specific individual, and responsively enabling at least one function of the wearable computing device.

2. The method of claim 1, wherein providing, by a wearable computing device, an indication for positioning a hand within a field of view of an image capture device comprises:
the wearable computing device operating the HMD to display an indication outline within which the hand is to be positioned.

3. The method of claim 2, further comprising:
detecting, by the wearable computing device, that the wearable computing device is in a donned state, wherein the wearable computing device operates the HMD to display the indication outline in response to detecting that the wearable computing device is in the donned state.

4. (canceled)

5. The method of claim 2, wherein detecting the match between the palmprint lines in the hand and the data profile corresponding to the specific individual comprises:
selecting a portion of the image data based on the indication outline;
comparing the selected portion of the image data to the data profile, wherein the data profile includes data indicative of the specific individual's hand; and
detecting a match between the selected portion of the image data and at least a portion of the data profile.

6. The method of claim 5, wherein the data profile including data indicative of the specific individual's hand comprises the data profile including at least one of a handprint of the specific individual's hand, a plurality of static-gesture images indicative of a gesture of the specific individual's hand, or a plurality of motion-gesture images indicative of a motion of the specific individual's hand.

7. The method of claim 2, further comprising:
receiving, by the wearable computing device, video data indicative of the field of view of the image capture device; and
the wearable computing device operating the HMD to display a video feed that is based on the video data and that includes the indication outline.

8. The method of claim 7, further comprising:
determining, by the wearable computing device, that the video data shows, positioned within the indication outline, an object consistent with the hand; and
in response to determining that the video data shows, positioned within the indication outline an object consistent with the hand, changing at least one of a color, thickness, or shape of the indication outline in the video feed.

9. The method of claim 2, further comprising:
further in response to determining that the image data includes palmprint lines in the hand that provide sufficient detail for use as input to the subsequent authentication process, changing at least one of a color, thickness, or shape of the indication outline in the video feed.

10. The method of claim 1, further comprising:
before determining that the image data includes palmprint lines in the hand that provide sufficient detail for use as input to the subsequent authentication process, determining, by the wearable computing device, that the image data includes palmprint lines in the hand that provide insufficient detail for use as input to the subsequent authentication process; and
in response to determining that the image data includes palmprint lines in the hand that provide insufficient detail for use as input to the subsequent authentication process, providing, by the wearable computing device, a prompt to obtain improved image data.

11-18. (canceled)

19. A non-transitory computer readable medium having stored thereon instructions that when executed by a wearable computing device cause the wearable computing device to perform operations comprising:
providing an indication for positioning a hand within a field of view of an image capture device;
receiving image data indicative of the field of view of the image capture device;
identifying the hand in the image data;
determining that the image data includes palmprint lines in the hand that provide sufficient detail for use as input to a subsequent authentication process that determines whether or not the palmprint lines match a data profile corresponding to a specific individual;
in response to determining that the image data includes palmprint lines in the hand that provide sufficient detail for use as input to the subsequent authentication process, (i) generating a graphic image of the palmprint lines and (ii) displaying, in a display of a head mountable display (HMD), the image data of the hand and the graphic image of the palmprint lines, wherein the graphic image of the palmprint lines is superimposed on the palmprint lines in the hand; and
detecting a match between the palmprint lines in the hand and the data profile corresponding to the specific individual, and responsively enabling at least one function of the wearable computing device.

20. The non-transitory computer readable medium of claim 19, wherein providing an indication for positioning a hand within a field of view of an image capture device comprises:
operating the HMD to display an indication outline within which the hand is to be positioned.

21. (canceled)

22. The non-transitory computer readable medium of claim 20,
wherein detecting the match between the palmprint lines in the hand and the data profile corresponding to the specific individual comprises:
selecting a portion of the image data based on the indication outline;
comparing the selected portion of the image data to the data profile, wherein the data profile includes data indicative of the specific individual's hand; and
detecting a match between the selected portion of the image data and at least a portion of the data profile.

23. The non-transitory computer readable medium of claim 22, wherein the data profile including data indicative of the specific individual's hand comprises the data profile including at least one of a handprint of the specific individual's hand, a plurality of static-gesture images indicative of a gesture of the specific individual's hand, or a plurality of motion-gesture images indicative of a motion of the specific individual's hand.

24. The non-transitory computer readable medium of claim 20, wherein the instructions are further executable by the wearable computing device to cause the wearable computing device to perform operations comprising:
receiving video data indicative of the field of view of the image capture device; and
operating the HMD to display a video feed that is based on the video data and that includes the indication outline.

25. The non-transitory computer readable medium of claim 24, wherein the instructions are further executable by the wearable computing device to cause the wearable computing device to perform operations comprising:
determining that the video data shows, positioned within the indication outline, an object consistent with the hand; and
in response to determining that the video data shows, positioned within the indication outline, an object consistent with the hand, changing at least one of a color, thickness, or shape of the indication outline in the video feed.

26. The non-transitory computer readable medium of claim 20, wherein the instructions are further executable by the wearable computing device to cause the wearable computing device to perform operations comprising:
further in response to determining that the image data includes palmprint lines in the hand that provide sufficient detail for use as input to the subsequent authentication process, changing at least one of a color, thickness, or shape of the indication outline in the video feed.

27. The non-transitory computer readable medium of claim 19, wherein the instructions are further executable by the wearable computing device to cause the wearable computing device to perform operations comprising:
before determining that the image data includes palmprint lines in the hand that provide sufficient detail for use as input to the subsequent authentication process, determining that the image data includes palmprint lines in the hand that provide insufficient detail for use as input to the subsequent authentication process; and
in response to determining that the image data includes palmprint lines in the hand that provide insufficient detail for use as input to the subsequent authentication process, providing a prompt to obtain improved image data.

28. A wearable computing device comprising:
an image capture device;
a head mountable display (HMD);
at least one processor; and
data storage storing instructions that when executed by the at least one processor cause the wearable computing device to perform operations comprising:
providing an indication for positioning a hand within a field of view of the image capture device;
receiving image data indicative of the field of view of the image capture device;
identifying the hand in the image data;
determining that the image data includes palmprint lines in the hand that provide sufficient detail for use as input to a subsequent authentication process that determines whether or not the palmprint lines match a data profile corresponding to a specific individual;
in response to determining that the image data includes palmprint lines in the hand that provide sufficient detail for use as input to the subsequent authentication process, (i) generating a graphic image of the palmprint lines and (ii) displaying, in a display of the HMD, the image data of the hand and the graphic image of the palmprint lines, wherein the graphic image of the palmprint lines is superimposed on the palmprint lines in the hand; and
detecting a match between the palmprint lines in the hand and the data profile corresponding to the specific individual, and responsively enabling at least one function of the wearable computing device.

29. The wearable computing device of claim 28, wherein providing an indication for positioning a hand within a field of view of an image capture device comprises operating the HMD to display an indication outline within which the hand is to be positioned, the operations further comprising:
receiving video data indicative of the field of view of the image capture device; and
operating the HMD to display a video feed that is based on the video data and that includes the indication outline.

30. The wearable computing device of claim 29, the operations further comprising:
further in response to determining that the image data includes palmprint lines in the hand that provide sufficient detail for use as input to the subsequent authentication process, changing at least one of a color, thickness, or shape of the indication outline in the video feed.
